(19) United States
(12) Patent Application Publication
(10) Pub. No.: US 2023/0080100 A1
(43) Pub. Date: Mar. 16, 2023

(54) METAL-AIR BATTERY

(71) Applicant: SHARP KABUSHIKI KAISHA, Sakai City, Osaka (JP)

(72) Inventors: TOMO KITAGAWA, Sakai City, Osaka (JP); AKIHITO YOSHIDA, Sakai City, Osaka (JP); HIROTAKA MIZUHATA, Sakai City, Osaka (JP); SHUNSUKE SATA, Sakai City, Osaka (JP)

(21) Appl. No.: 17/801,205

(22) PCT Filed: Oct. 20, 2020
(86) PCT No.: PCT/JP2020/039443

§ 371 Date: Aug. 19, 2022

(30) Foreign Application Priority Data
Mar. 3, 2020 (JP) 2020-035455

(51) Int. Cl. H01M 12/08; H01M 4/80; H01M 12/02; H01M 12/06; H01M 4/66

(52) U.S. Cl. CPC H01M 12/08; H01M 4/80; H01M 12/02; H01M 12/06; H01M 4/66

(57) ABSTRACT

A metal-air battery from which leakage of an electrolytic solution is reduced is provided. The metal-air battery includes: a positive electrode including: a current collector; and a catalyst layer formed on the current collector and capable of reducing oxygen; a negative electrode disposed to face the positive electrode; an exterior body housing a stacked portion including the positive electrode and the negative electrode, and having an opening formed to open to the positive electrode; an electrolyte disposed inside the exterior body; and a water-repellent film covering the opening, including a joint portion joined to the exterior body, and transparent to oxygen. The catalyst layer includes a portion positioned between the joint portion and the current collector.

### TECHNICAL FIELD

The present disclosure relates to a metal-air battery. The present application claims priority to Japanese Patent Application No. 2020-035455, filed on Mar. 3, 2020, the contents of which are incorporated herein by reference in its entirety.

### BACKGROUND ART

For example, Patent Document 1 describes an example of a metal-air battery. The metal-air battery described in Patent Document 1 includes: a positive electrode; a negative electrode; a separator disposed between the positive electrode and the negative electrode; an electrolytic solution; and an exterior body to house the positive electrode, the negative electrode, the separator, and the electrolytic solution. On a surface, of the exterior body, toward the positive electrode, an air hole is formed. Between the exterior body and the positive electrode, a water-repellent film is disposed.

### CITATION LIST

### Patent Literature

Patent Document 1 Japanese Unexamined Patent Application Publication No. 2019-067616

### SUMMARY OF INVENTION

### Technical Problem

A request to the metal-air battery is to reduce leakage of the electrolytic solution housed in the exterior body.

A main object of the present disclosure is to provide a metal-air battery from which leakage of an electrolytic solution is reduced.

### Solution to Problem

A metal-air battery according to an aspect of the present invention includes: a positive electrode including: a current collector; and a catalyst layer formed on the current collector and capable of reducing oxygen; a negative electrode disposed to face the positive electrode; an exterior body housing a stacked portion including the positive electrode and the negative electrode, and having an opening formed to open to the positive electrode; an electrolyte disposed inside the exterior body; and a water-repellent film covering the opening, including a joint portion joined to the exterior body, and transparent to oxygen, wherein the catalyst layer includes a portion positioned between the joint portion and the current collector.

### BRIEF DESCRIPTION OF DRAWINGS

FIG. 1 is a schematic plan view of a metal-air battery according to a first embodiment.

FIG. 2 is a schematic cross-sectional view taken from line II-II of FIG. 1.

FIG. 3 is a schematic cross-sectional view taken from line II-III of FIG. 1.

FIG. 4 is a schematic cross-sectional view taken from line IV-IV of FIG. 1.

FIG. 5 is a schematic cross-sectional view of the metal-air battery according to the first embodiment, with the metal-air battery partially enlarged.

### DESCRIPTION OF EMBODIMENTS

Examples of preferable embodiments of the present invention are described below. Note that the embodiments below are merely examples. The present invention shall not be limited to the embodiments below

### First Embodiment

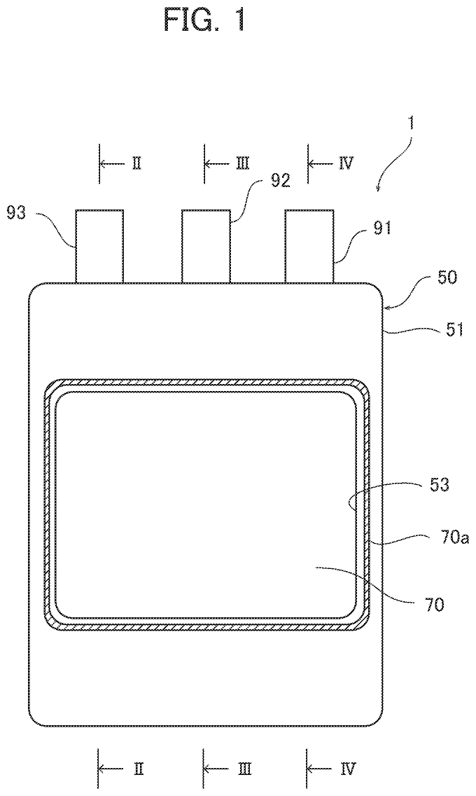

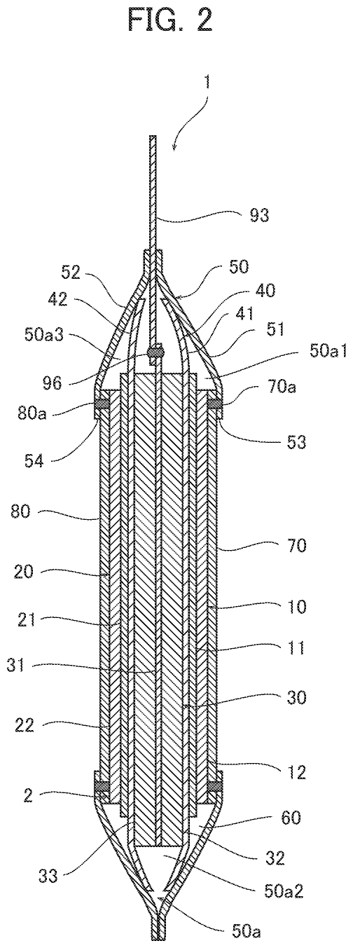

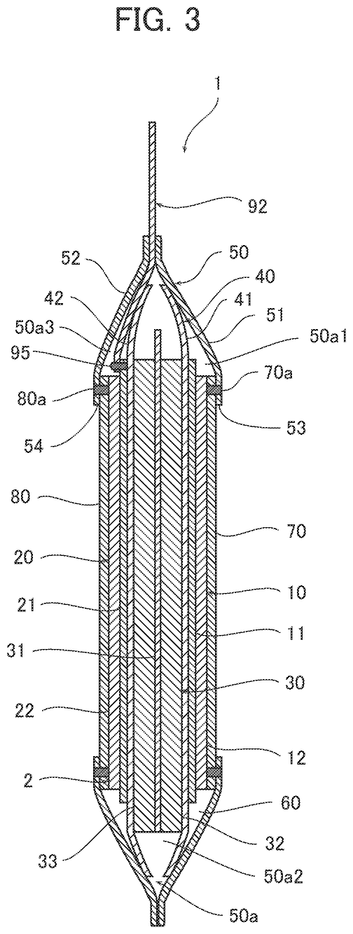

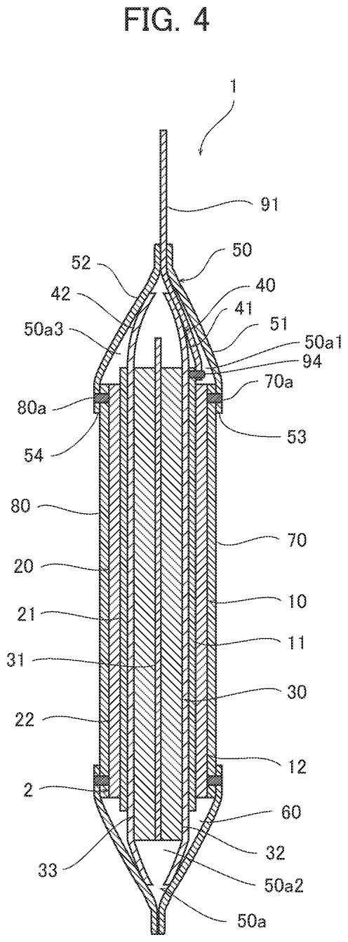

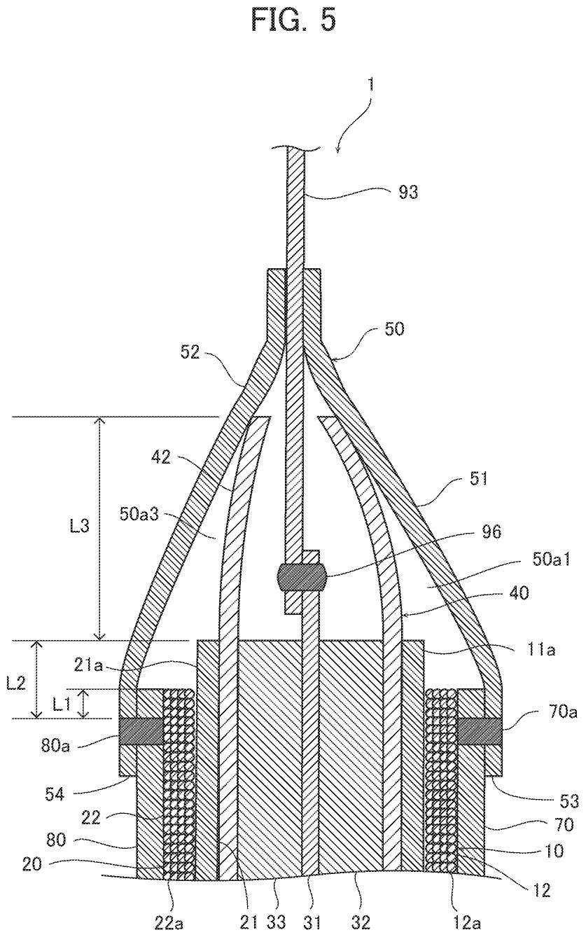

FIG. 1 is a schematic plan view of a metal-air battery according to a first embodiment. FIG. 2 is a schematic cross-sectional view taken from line II-II of FIG. 1. FIG. 3 is a schematic cross-sectional view taken from line III-III of FIG. 1. FIG. 4 is a schematic cross-sectional view taken from line IV-IV of FIG. 1. FIG. 5 is a schematic cross-sectional view of the metal-air battery according to the first embodiment, with the metal-air battery partially enlarged.

In FIGS. 1 to 5 a metal-air battery 1 according to the first embodiment is a primary battery. In this embodiment, an example of a metal-air battery as a primary battery is described. Note that, in the present invention, the metal-air battery shall not be limited to a primary battery. The metal-air battery may be, for example, a secondary battery.

As illustrated in FIGS. 2 to 4, the metal-air battery 1 includes: a first positive electrode 10; a second positive electrode 20; and a negative electrode 30.

### First Positive Electrode 10 and Second Positive Electrode 20

The first positive electrode 10 includes: a positive electrode current collector 11; and a catalyst layer 12.

The positive electrode current collector 11 is formed of a flexible sheet member. The positive electrode current collector 11 can be formed of a suitable conductive material. The positive electrode current collector 11 may be formed of such a metal as, for example, Ni. The positive electrode current collector 11 is preferably formed of such a porous solid as, for example, a metal porous solid. When the positive electrode current collector 11 is formed of a porous solid, an area of contact between the positive electrode 11 and the catalyst layer 12 can increase. Hence, the first positive electrode 10 can increase in power collection efficiency.

The positive electrode 11 has any given thickness. For example, the positive electrode current collector 11 has a thickness of preferably 50 μm or more and 500 μm or less, and, more preferably, 100 μm or more and 300 μm or less. If the positive electrode current collector 11 is excessively thin, the positive electrode current collector 11 might exhibit an increase in resistivity and a decrease in mechanical strength. If the positive electrode current collector 11 is excessively thick, the metal-air battery 1 might exhibit a decrease in energy density.

On the positive electrode current collector 11, the catalyst layer 12 is formed. The catalyst layer 12 is capable of reducing oxygen. Specifically, the catalyst layer 12 contains an oxygen-reducing catalyst capable of reducing oxygen. Examples of the oxygen-reducing catalyst include a carbon material, a metal oxide such as manganese oxide, and a precious metal such as platinum (Pt). Examples of the carbon material include ketjen black, acetylene black, denka black, carbon nanotubes, fullerenes, and grapheme.

The catalyst layer 12 may contain, for example, a plurality of catalyst particles 12a containing an oxygen-reducing catalyst (see FIG. 5). The plurality of catalyst particles 12a have any given average particle size. For example, the catalyst particles 12a have an average particle size of preferably 10 nm or more and 1 μm or less, and, more preferably, 20 nm or more and 100 nm or less.

The catalyst layer 12 may further contain such a substance as resin disposed between the catalyst particles 12a. In such a case, the resin functions as a binder, making it possible to further bind together the plurality of catalyst particles 12a. An example of the resin to be preferably used is a fluorine-containing resin such as polytetrafluoroethylene (PTFE).

The catalyst layer 12 is preferably flexible.

The catalyst layer 12 has any given thickness. For example, the catalyst layer 12 has a thickness of preferably 200 μm or more and 1000 μm or less, and, more preferably, 400 μm or more and 800 μm or less.

The second positive electrode 20 faces the first positive electrode 10 at an interval. The second positive electrode 20 includes: a positive electrode current collector 21; and a catalyst layer 22.

The positive electrode current collector 21 is substantially the same in configuration as the positive electrode current collector 11. Hence, the description of the positive electrode current collector 11 is employed to describe the positive electrode current collector 21.

The catalyst layer 22 is substantially the same in configuration as the catalyst layer 12. Hence, the description of the catalyst layer 12 is employed to describe the catalyst layer 22.

### Negative Electrode 30

The negative electrode 30 is stacked with the first positive electrode 10 and the second positive electrode 20 respectively through a first separator piece 41 and a second separator piece 42. The negative electrode 30 is disposed between the first positive electrode 10 and the second positive electrode 20. The negative electrode 30 has one face facing the first positive electrode 10, and another face facing the second positive electrode 20.

The negative electrode 30 includes: a negative current collector 31; and negative active material layers 32 and 33.

The negative current collector 31 is formed of a flexible sheet member. The negative electrode current collector 31 can be formed of a suitable conductive material. The negative electrode current collector 31 may be formed of such a metal as, for example, Cu.

Each side of the negative current collector 31 is provided with one of the negative active material layers 32 and 33. Specifically, the negative current collector 31 has one face provided with the negative active material layer 32, and another face provided with the negative active material layer 33.

The negative active material layers 32 and 33 each contain a negative active material,

Examples of the negative active material include: such metals as cadmium, lithium, sodium, magnesium, zinc, tin, aluminum, and iron; an alloy containing at least one of the metals; and oxides of the metals. In particular, if the metal-air battery 1 is a zinc-air battery, such substances as zinc, a zinc alloy, and zinc oxide are preferably used as the negative active materials. If the metal-air battery 1 is a magnesium-air battery, such substances as magnesium, a magnesium ahoy, and magnesium oxide are preferably used as the negative active materials. If the metal-air battery 1 is a lithium-air battery, such substances as lithium, a lithium alloy, and lithium-containing oxide are preferably used as the negative active materials.

Each of the negative active material layers 32 and 33 may include, for example, a plurality of negative active material particles containing a negative active material. The plurality of negative active material particles may be, or may not be, bound together. For example, each of the negative active material layers 32 and 33 may include: an electrolytic solution; and slurry containing the plurality of negative active material particles.

### Separator 40

A separator 40 is disposed each of between the first positive electrode 10 and the negative electrode 30 and between the second positive electrode 20 and the negative electrode 30. This separator 40 electrically separates the positive electrodes 10 and 20 from the negative electrode 30.

The separator 40 has any given thickness. Preferably, the separator 40 has a thickness of 0.05 mm or more and 0.4 mm or less. If the thickness of the separator 40 is less than 0.05 mm, the separator 40 might be broken with a volume change of the negative electrode. Meanwhile, if the thickness of the separator exceeds 0.4 mm, the internal resistance increases. As a result, the power of the battery might decrease.

The separator 40 includes: the first separator piece 41; and the second separator piece 42. The first separator piece 41 is positioned between the first positive electrode 10 and the negative electrode 30. In this embodiment, the first separator piece 41 has a peripheral portion joined to the exterior body 50. The first separator piece 41 and the exterior body 50 may be joined together by any given technique. The first separator piece 41 and the exterior body 50 may be welded together by such welding techniques as heat sealing and ultrasonic welding.

Meanwhile, the second separator piece 42 is positioned between the second positive electrode 20 and the negative electrode 30. The second separator piece 42 has a peripheral portion joined to the exterior body 50. The second separator piece 42 and the exterior body 50 may be joined together by any given technique. The second separator piece 42 and the exterior body 50 may be welded together by such welding techniques as heat sealing and ultrasonic welding.

As can be seen, in this embodiment, the first separator piece 41 and the second separator piece 42 have their respective peripheral portions entirely joined to the exterior body 50. Hence, an interior space 50a inside the exterior body 50 is divided by the first separator piece 41 and the second separator piece 42 into a first interior space 50a1, a second interior space 50a2, and a third interior space 50a3. The first interior space 50a1 is provided with the first positive electrode 10. The second interior space 50a2 is provided with the negative electrode 30. The third interior space 50a3 is provided with the second positive electrode 20.

Each of the first separator piece 41 and the second separator piece 42 is formed of an insulating sheet. Each of the first separator piece 41 and the second separator piece 42 can be formed of such a material as a porous sheet or an ion-exchange membrane containing such a resin as, for example, polyethylene, polypropylene, or polyolefin.

The first separator piece 41 and the second separator piece 42 are preferably flexible.

At least a portion of the first positive electrode 10, at least a portion of the second positive electrode 20, at least a portion of the negative electrode 30, and at least a portion of the separator 40 are stacked together. Hereinafter, a stacked product of at least a portion of the first positive electrode 10, at least a portion of the second positive electrode 20, at least a portion of the negative electrode 30, and at least a portion of the separator 40 is referred to as a stacked product 2.

### Exterior Body 50

The exterior body 50 houses the stacked product 2. Specifically, the interior space 50a of the exterior body 50 is provided with the stacked product 2.

The exterior body 50 includes: a first flexible film 51; and a second flexible film 52. A peripheral portion of the first flexible film 51 and a peripheral portion of the second flexible film 52 are joined together (e.g. laminated together) to form the exterior body 50 having the interior space 50a.

The exterior body 50 is preferably formed of, for example, a resin film, and, more preferably, formed of a thermoplastic resin film. The thermoplastic resin film to be preferably used include a resin film formed of such a polyolefin as polypropylene or polyethylene. Moreover, the exterior body 50 may include at least one resin layer and at least one metal layer. Specifically, the exterior body 50 may include a metal layer and resin layers each positioned to either side of the metal layer.

The exterior body 50 has any given thickness, such as a thickness of preferably 30 μm or more and 300 μm or less, more preferably, 50 μm or more and 200 μm or less, and still more preferably, 80 μm or more and 150 μm or less.

In view of providing the exterior body 50 with more strength, the first flexible film 51 and the second flexible film 52 are preferably formed of a solid film.

Here, the term “solid film” means a film that does not substantially contain therein pores. Under 1 atm, the solid film preferably has an oxygen transmission rate per 24 hours of 300 cm³/m²

The exterior body 50 has openings 53 and 54. The openings 53 and 54 are respectively open to the positive electrodes 10 and 20.

The opening 53 is formed on the first flexible film 51 of the exterior body 50. Of the first positive electrode 10 and the second positive electrode 20, the opening 53 is open to the first positive electrode 10 positioned toward the first flexible film 51. In particular, the opening 53 is open to a portion of the first positive electrode 10. The portion is included in the stacked product 2, except for a peripheral portion of the stacked product 2. That is, the opening 53 is open to a portion of the stacked product 2, except for the peripheral portion of the stacked product 2. Specifically, the opening 53 is open to a region, of the stacked body 2, whose area preferably accounts for 80% or more of, and more preferably 90% or more of, a main surface of the stacked product 2. The opening 53 exposes a portion of a water-repellent film 70, except for a peripheral portion of the water-repellent film 70. When the opening 53 is formed large in size, the air (oxygen) can be supplied highly efficiently from the opening 53 to the first positive electrode 10.

The opening 54 is formed on the second flexible film 52 of the exterior body 50. Of the first positive electrode 10 and the second positive electrode 20, the opening 54 is open to the second positive electrode 20 positioned toward the second flexible film 52. In particular, the opening 54 is open to a portion of the second positive electrode 20. The portion is included in the stacked product 2, except for a peripheral portion of the stacked product 2. That is, the opening 54 is open to a portion of the stacked product 2, except for the peripheral portion of the stacked product 2. Specifically, the opening 54 is open to a region, of the stacked body 2, whose area preferably accounts for 80% or more of, and more preferably 90% or more of, a main surface of the stacked product 2. The opening 54 exposes a portion of a water-repellent film 80, except for a peripheral portion of the water-repellent film 80. When the opening 54 is formed large in size, the air (oxygen) can be supplied highly efficiently from the opening 54 to the second positive electrode 20.

Note that this embodiment describes an example in which one each of the openings 53 and 54 is formed to open across the stacked product 2, except for the peripheral portions of the stacked product 2. Note that the present invention shall not be limited to this configuration. For example, each of the first flexible film and the second flexible film may include a plurality of openings that are provided at intervals and open to the positive electrode. Specifically, for example, a plurality of rectangular or circular openings may be formed in a matrix.

The shape of each of the openings 53 and 54 shall not be limited to a particular shape. The shapes of the openings 53 and 54 may be, for example, polygons such as rectangles, circles, ellipses, and ovals. The openings 53 and 54 are preferably shaped substantially similarly in planar view to the stacked product 2 in plan view. For example, if the stacked product 2 is substantially rectangular in planar view, the openings 53 and 54 are preferably rectangular.

### Electrolyte 60

The interior space 50a of the exterior body 50 is provided with an electrolyte 60. Specifically, the interior space 50a is filled with the electrolyte 60. The electrolyte 60 preferably contains at least water. The electrolyte 60 may be, for example, an electrolytic solution, or a gel electrolyte. As the electrolyte 60, an electrolytic solution may be used more preferably.

The description below is an example in which the electrolyte 60 is formed of an electrolytic solution.

The electrolyte 60 formed of an electrolytic solution contains a solvent and a solute. Because the electrolyte 60 is preferably an aqueous solution, the solvent preferably contains, for example, water. The solvent may be, for example, either water or a mixture of water and, for example, alcohol. If the metal-air battery 1 is a zinc-air battery, the electrolyte 60 is preferably an alkaline aqueous solution. The solute to be preferably used includes a hydroxide containing alkali metal or alkali-earth metal (e.g. potassium hydroxide and sodium hydroxide). Moreover, if the metal-air battery 1 is a zinc-air battery, the electrolyte 60 may contain zinc ions. If the metal-air battery 1 is a magnesium-air battery, the electrolyte 60 is preferably a neutral aqueous solution such as a sodium-chloride aqueous solution. If the metal-air battery 1 is a lithium-air battery, the electrolyte 60 may be a non-aqueous electrolyte to be used as an electrolyte of a lithium-ion battery.

### Water-Repellent Films 70 and 80

The water-repellent films 70 and 80 cover the openings 53 and 54. In particular, the water-repellent film 70 covers the opening 53. The water-repellent film 80 covers the opening 54. The water-repellent film 70 is positioned between the first flexible film 51 on which the opening 53 is formed and the first positive electrode 10. The water-repellent film 80 is positioned between the second flexible film 52 on which the opening 54 is formed and the second positive electrode 20.

The water-repellent films 70 and 80 are larger in area than the openings 53 and 54. The water-repellent films 70 and 80 are disposed inside the exterior body 50 (inside the interior space 50a). At least a portion of periphery portions of the water-repellent films 70 and 80 is joined to the exterior body 50. Of the periphery portions of the water-repellent films 70 and 80, portions joined to the exterior body 50 include joint portions 70a and 80a.

In particular, the water-repellent film 70 is larger in area than the opening 53. The water-repellent film 70 is disposed between the first flexible film 51 on which the opening 53 is formed and the stacked product 2. At least a portion of the periphery portion of the water-repellent film 70 is the joint portion 70a joined to the exterior body 50 (specifically, to the first flexible film 51). The joint portion 70a is shaped into a frame to surround the opening 53.

The water-repellent film 80 is larger in area than the opening 54. The water-repellent film 80 is disposed between the second flexible film 52 on which the opening 54 is formed and the stacked product 2. At least a portion of the periphery portion of the water-repellent film 80 is the joint portion 80a joined to the exterior body 50 (specifically, to the second flexible film 52). As illustrated in FIG. 1, the joint portion 80a is shaped into a frame to surround the opening 54.

The water-repellent films 70 and 80 are transparent to oxygen, and substantially block the electrolyte. Specifically, in this embodiment, each of the water-repellent films 70 and 80 is formed of a porous solid. More specifically, each of the water-repellent films 70 and 80 is formed of a porous film. The water-repellent films 70 and 80 include a plurality of through pores penetrating in the thickness direction. Hence, such a gas as oxygen can pass through the water-repellent films 70 and 80 via the through pores. Note that the water-repellent films 70 and 80 have any given porosity. For example, the water-repellent films 70 and 80 have a porosity of, in volume percent, preferably 20% or more and 95% or less, and more preferably, 60% or more and 90% or less.

Surfaces of the water-repellent films 70 and 80 (specifically both the outer surfaces and the inner surfaces) are water repellent. Here, the term “water repellent” is a property to repel the electrolyte (in particular, the solvent contained in the electrolyte). Hence, because the surfaces of the water-repellent films 70 and 80 are water repellent, the electrolyte is kept from entering the through pores formed in the water-repellent films 70 and 80. Thus, the water-repellent films 70 and 80 substantially block the electrolyte.

The water-repellent films 70 and 80 may be formed of any given material. The water-repellent films 70 and 80 can be formed of, for example, a suitable resin. The water-repellent films 70 and 80 are preferably formed of, for example, a fluorine-containing resin such as PTFE.

Note that, unlike the water-repellent films 70 and 80, the exterior body 50 in this embodiment is formed of a solid film, and substantially blocks not only the electrolyte 60 but also such a gas as oxygen.

The water-repellent films 70 and 80 have any given thickness. Specifically, the water-repellent films 70 and 80 have a thickness of preferably 10 μm or more and 300 μm or less, more preferably, 20 μm or more and 200 μm or less, and still more preferably, 30 μm or more and 50 μm or less.

Hence, in this embodiment, the exterior body 50 is solid; whereas, the water-repellent films 70 and 80 are porous. Hence, the water-repellent film 70 and 80 are low in mechanical robustness than the exterior body 50. That is, the water-repellent films 70 and 80 are more likely to be broken than the exterior body 50.

### Leads 91, 92, and 93

The first positive electrode 10, the second positive electrode 20, and the negative electrode 30 are disposed inside the interior space 50a of the exterior body 50. A lead 91, a lead 92, and a lead 93 are respectively connected to the first positive electrode 10, the second positive electrode 20, and the negative electrode 30. These leads 91, 92, and 93 respectively extend the first positive electrode 10, the second positive electrode 20, and the negative electrode 30 out of the exterior body 50. Note that each of the leads 91, 92, and 93 may be formed of, for example, metal foil.

Specifically, to the positive electrode current collector 11 of the first positive electrode 10, a portion, of the first positive electrode lead 91, positioned in the interior space 50a is connected. The first positive electrode lead 91 is extended from the positive electrode current collector 11 out of the exterior body 50. The positive electrode current collector 11 and the first positive electrode lead 91 may be connected together by any given connection technique as long as they are electrically connected together. The positive electrode current collector 11 and the first positive electrode lead 91 may be, for example, welded together. A portion of the positive electrode current collector 11 may extend and form a portion of the first positive electrode lead 91. If the positive electrode current collector 11 and the first positive electrode lead 91 are welded together, the positive electrode current collector 11 and the first positive electrode lead 91 have a joint portion 94 typically thicker than either the positive electrode current collector 11 or the first positive electrode lead 91.

To the positive electrode current collector 21 of the second positive electrode 20, a portion, of the second positive electrode lead 92, positioned in the interior space 50a is connected. The second positive electrode lead 92 is extended from the positive electrode current collector 21 out of the exterior body 50. The positive electrode current collector 21 and the second positive electrode lead 92 may be connected together by any given connection technique as long as they are electrically connected together. The positive electrode current collector 21 and the second positive electrode lead 92 may be, for example, welded together. A portion of the positive electrode current collector 21 may extend and form a portion of the second positive electrode lead 92. If the positive electrode current collector 21 and the second positive electrode lead 92 are welded together, the positive electrode current collector 21 and the second positive electrode lead 92 have a joint portion 95 typically thicker than either the positive electrode current collector 21 or the second positive electrode lead 92.

The first positive electrode lead 91 and the second positive electrode lead 92 may be connected together out of the exterior body 50.

To the negative current collector 31 of the negative electrode 30, a portion, of the negative electrode lead 93, positioned in the interior space 50a is connected. The negative electrode lead 93 is extended from the negative current collector 31 out of the exterior body 50. The negative current collector 31 and the negative electrode lead 93 may be connected together by any given connection technique as long as they are electrically connected together. The negative current collector 31 and the negative electrode lead 93 may be, for example, welded together. A portion of the negative current collector 31 may extend and form a portion of the negative electrode lead 93. If the negative current collector 31 and the negative electrode lead 93 are welded together, the negative current collector 31 and the negative electrode lead 93 have a joint portion 96 typically thicker than either the negative current collector 31 or the negative electrode lead 93.

### Discharge Reaction of Metal-Air Battery 1

Next, citing a case where the metal-air battery 1 is a zinc-air battery, a discharge reaction of the metal-air battery 1 is described.

When the metal-air battery 1 as a zinc-air battery is discharged, reactions represented by the expressions shown below develop in the first positive electrode 10, the second positive electrode 20, and the negative electrode 30.

A reaction of the positive electrodes at discharge: O₂+2H₂O+4e⁻→4OH⁻

A reaction of the negative electrode at discharge: Zn+4OH—→Zn(OH)²⁻₄+2e⁻→ZnO+H₂O+2OH⁻+2e⁻

The above reaction of the positive electrodes 10 and 20 develops in the catalyst layers 12 and 22 by action of the catalyst contained in the catalyst layers 12 and 22. At discharge, as shown by the above expressions, the catalyst contributes to reduction of oxygen.

As can be seen above, the catalyst layers 12 and 22 need oxygen for the discharge reaction. Hence, the catalyst layers 12 and 22 need to be supplied with oxygen. If the efficiency in oxygen supply to the catalyst layers 12 and 22 is low, the efficiency in discharge reaction of the catalyst layers 12 and 22 falls. From this viewpoint, the catalyst layers 12 and 22 are preferably disposed, in planar view, only in the regions in which the openings 53 and 54 are provided. Thus, the catalyst layers are not typically disposed in the region in which the exterior body 50 blocking oxygen is provided.

However, the inventors of the present invention have conducted through studies, and, as a result, found out that, if the catalyst layers are provided only in the regions in which the openings are provided, the electrolyte might leak. Thus, the inventors have arrived at the metal-air battery 1 according to this embodiment.

In this embodiment, the catalyst layer 12 includes a portion positioned between the joint portion 70a and the positive electrode current collector 11. Hence, for example, even if the metal-air battery 1 is stressed and the positive electrode current collector 11 is deformed, the catalyst layer 12 is positioned between the positive electrode current collector 11 and the joint portion 70a. Hence, the positive electrode current collector 11 is kept from direct contact with the joint portion 70a and a portion, of the water-repellent film 70, positioned behind the joint portion 70a. Thus, the metal-air battery 1 reduces the risk that the water-repellent film 70 breaks. Likewise, the catalyst layer 22 includes a portion positioned between the joint portion 80a and the positive electrode current collector 21, reducing the risk that the water-repellent film 80 breaks. Such a feature can reduce leak of the electrolyte 60.

In view of reducing more effectively the leak of the electrolyte 60 caused by the contact between the positive electrode current collectors 11 and 21 and the catalyst layers 12 and 22, the catalyst layer 12 is preferably thicker than the positive electrode current collector 11. The catalyst layer 22 is preferably thicker than the positive electrode current collector 22. The catalyst layers 12 and 22 are thicker than the positive electrode current collectors 11 and 21. Hence, even if the positive electrode current collectors 11 and 12 dig into the catalyst layers 12 and 22, the thickness of the catalyst layers 12 and 22 can effectively reduce the risk that the positive electrode current collectors 11 and 12 come into contact with, and break, the water-repellent films 70 and 80. In view of reducing the leak of the electrolyte 60 still more effectively, the catalyst layers 12 and 22 are preferably twice as thick as, or more than twice as thick as, the positive electrode current collectors 11 and 21. Note that if the catalyst layers 12 and 22 are excessively thick, the catalyst layers 12 and 22 produce therein a portion with low oxygen supply efficiency. As a result, the energy density might decrease. Hence, the catalyst layers 12 and 22 are preferably seven times as thick as, or thinner than seven times the thickness of, the positive electrode current collectors 11 and 21. Specifically, the positive electrodes 11 and 21 have a thickness of preferably 50 μm or more and 500 μm or less, and, more preferably, 100 μm or more and 300 μm or less. The catalyst layers 12 and 22 have a thickness of preferably 200 μm or more and 1000 μm or less, and, more preferably, 400 μm or more and 800 μm or less.

The effect of reducing the leak of the electrolyte 60 is achieved if the catalyst layers12 and 22 are at least partially positioned between: the joint portions 70a and 80a; and the positive electrode current collectors 11 and 21. Note that, in view of reducing the leak of the electrolyte 60 still more effectively from the metal-air battery 1, the catalyst layers 12 and 22 preferably cover substantially all of, and more preferably cover all of, the joint portions 70a and 80a toward the positive electrode current collectors 11 and 12.

Likewise, in planar view, when a distance of 100 is set between: a portion at which the separator 40 and the exterior body 50 join together; and the joint portions 70a and 80a of the water-repellent films 70 and 80 and the exterior body 50, a distance of 20 or more may preferably be set between: the joint portions 70a and 80a of the water-repellent films 70 and 80 and the exterior body 50; and outer end portions of the catalyst layers 12 and 22.

Moreover, in view of reducing the leak of the electrolyte 60, the joint portions 70a and 80a are preferably kept from great stress to be given with the deformation of the metal-air battery 1. From such a viewpoint, the positive electrode current collectors 11 and 21 preferably extend out of the joint portions 70a and 80a. In planar view, when a distance of 100 is set between: a portion at which the separator 40 and the exterior body 50 join together; and the joint portions 70a and 80a of the water-repellent films 70 and 80 and the exterior body 50, a distance of 20 or more may preferably be set between: the joint portions 70a and 80a of the water-repellent films 70 and 80 and the exterior body 50; and outer end portions of the positive electrode current collector 11 and 21.

Note that if the positive electrode current collectors 11 and 21 are excessively long, the positive electrode current collectors 11 and 21 might come into contact with, and damage, the portion at which the separator 40 and the exterior body 50 join together. In such a case, for example, the negative active material particles flow out toward the positive electrodes 10 and 20, causing short circuit inside the metal-air battery 1. As a result, the battery temperature might rise and the battery characteristic might deteriorate. Hence, in planar view when a distance of 100 is set between: the portion at which the separator 40 and the exterior body 50 join together; and the joint portions 70a and 80a of the water-repellent films 70 and 80 and the exterior body 50, preferably, a distance of 10 or more, more preferably 15 or more, and still more preferably 20 or more, may be set in planar view between: the portion at which the separator 40 and the exterior body 50 join together; and end portions of the positive electrode current collectors 11 and 21.

As can be seen, in this embodiment, the catalyst layers 12 and 22 have a shock absorption effect. Hence, the catalyst layers 12 and 22 are preferably highly effective in absorbing shock. From this viewpoint, the catalyst layers 12 and 22 preferably contain a plurality of catalyst particles 12a and 22a. In such a case, the catalyst particles 12a and 22a have an average particle size of one-fifty thousandth times or more and one-fiftieth times or less of, and more preferably, one-fifteen thousandth times or more and one-five hundredth times or less of, the thickness of the positive electrode current collectors 11 and 21.

Moreover, in view of improving the shock absorption effect of the catalyst layers 12 and 22, the catalyst layers 12 and 22 preferably contain resin. Note that the catalyst layers 12 and 22 have a resin content of, in weight percent, preferably 30% or less. This is because if the resin content is excessively high, the energy density would be excessively low.

In view of reducing still more effectively the leak of the electrolyte 60, caused by damage to the water-repellent films 70 and 80, from the metal-air battery 1, the positive electrode current collectors 11 and 21 respectively include outer portions 11a and 21a positioned out of the joint portions 70a and 80a. In such a case, the leads 91 and 92 may be electrically connected to the outer portions 11a and 21a. Hence, the joint portions 94 and 95, which could often be formed thick, and the stacked product 2, which has a great thickness, can be kept from overlapping in the stacking direction. Hence, the water-repellent films 70 and 80 can be kept from great stress. As a result, damage to the water-repellent films 70 and 80 can be reduced.

It is preferable for any metal-air battery 1 to provide the catalyst layers 12 and 22 between: the joint portions 70a and 80a; and the positive electrode current collectors 11 and 21, and it is more preferable if, for example, the positive electrode current collectors 11 and 21 are metal porous solids. This is because the positive electrode current collectors 11 and 21 are more likely to damage the joint portions 70a and 80a and the water-repellent films 70 and 80. Moreover, this is particularly preferable in the cases where the water-repellent films 70 and 80 are formed of porous films prone to damage, and where the water-repellent films 70 and 80 are thin, that is, a thickness of 20 μm or more and 200 μm or less.

### Modifications

In the above embodiment, the metal-air battery 1 as a primary battery is described. Note that the present invention shall not be limited to this configuration. The metal-air battery may be, for example, a secondary battery. In a secondary metal-air battery, each of the catalyst layer 12 and the catalyst layer 22 may contain not only a catalyst capable of reducing oxygen but also a catalyst capable of producing oxygen. Each of the catalyst layer 12 and the catalyst layer 22 may contain a bi-functional catalyst capable of both reducing oxygen and producing oxygen. The oxygen-producing catalyst capable of producing oxygen and the bi-functional catalyst shall not be limited to particular catalysts as long as the materials of the catalysts are typically used in this field. In such a case, the positive electrodes can also be used as charge electrodes and as discharge electrodes.

For example, the secondary metal-air battery may be a secondary three-electrode metal-air battery including a positive electrode as a discharge electrode and a positive electrode as a charge electrode. The secondary three-electrode metal-air battery may have, specifically, a Ni electrode capable of producing oxygen as a charge electrode, instead of the second positive electrode 20. Moreover, in the case of secondary three-electrode metal-air battery, the first positive electrode lead 91 and the second positive electrode lead 92 do not join together.

### Examples 1 to 5

With the procedure below, metal-air batteries 1 according to the above embodiment and a metal-air battery having substantially the same configuration as the metal-air batteries 1 were produced.

First, as a member to form the exterior body, a 110 mm×110 mm squared resin film was prepared. The resin film is a stacked product of a nylon (registered trademark) film having a thickness of 15 μm and a polyethylene (PE) film having a thickness of 100 μm.

Next, in a center portion of the resin film, a 60 mm×60 mm opening was formed.

Next, to cover the opening of the resin film on which the opening was formed, a water-repellent film made of a polytetrafluoroethylene film having a size of 70 mm×70 mm and a thickness of 200 μm was disposed. The water-repellent film was heat sealed to the resin film. The sealing width was 2 mm.

Next, on the water-repellent film, a 70 mm×70 mm catalyst layer was stacked. The catalyst layer is a porous solid (a thickness: 500 μm) containing MnO₂ as an oxygen-reducing catalyst, acetylene black as an oxygen-reducing catalyst and conductive agent, and polytetrafluoroethylene as a binder.

On the catalyst layer, a 77 mm×70 mm positive electrode current collector to which a lead was connected was stacked. The positive electrode current collector is an expanded Ni foil having a thickness of 100 μm.

Next, the above materials were bonded together by pressure boding.

Next, on the positive electrode current collector, a first separator piece was stacked. A peripheral portion of the first separator piece was heat sealed to the resin film. The first separator piece is a 92 mm×80 mm polyolefin nonwoven fabric having a thickness of 200 μm.

Next, on the first separator piece, a 77 mm×70 mm negative current collector was stacked. The negative electrode current collector is an expanded Cu foil having a thickness of 200 μm. The negative electrode current collector includes a lead made of a 50 mm×10 mm Ni foil having a thickness of 100 μm.

By the above process, a first stacked product was formed.

Next, in a similar manner as the above process, a second resin film, a second water-repellent film, a catalyst layer, a positive electrode current collector, and a second separator piece were stacked together and heat sealed to form a second stacked product.

Next, the first stacked product and the second stacked product were stacked together so that the first separator piece and the second separator piece faced each other across the negative current collector. Except for one side, three sides of a pair of the resin films were sealed together in a sealing width of 2 mm.

Next, from the unsealed one side of the pair of the resin films, an electrolytic solution and a negative active material were inserted in between the first separator piece and the second separator piece. The electrolytic solution is a 7M KOH aqueous solution. The negative active material particles are zinc powder. After the electrolytic solution and the negative active material were inserted, the remaining one side of the first resin film and the remaining one side of the second resin film were sealed together. Specifically, overlapping portions of the first resin film and the second resin film were sealed together in a sealing width of 4 mm.

In the above procedure, metal-air batteries were produced under the conditions cited in Table 1.

### Comparative Example

Other than the conditions cited in Table 1, a metal-air battery was produced in a similar manner as Examples 1 to 5.

TABLE 1

| | | | | Presence or Absence | | Result of Leakage |
|---|---|---|---|---|---|---|
| | | | | of Leakage of Liquid | Temperature Rise | of Liquid after |
| | L1 | L2 | L3 | after Drop Test | after Drop Test | Discharge Test |
| Comparative | −30 | −30 | 110 | Leaked | Less than 5° C. | x |
| Example | | | | | | |
| Example 1 | 0 | 0 | 100 | Not Leaked | Less than 5° C. | Δ |
| Example 2 | 0 | 10 | 90 | Not Leaked | Less than 5° C. | Δ |
| Example 3 | 0 | 20 | 80 | Not Leaked | Less than 5° C. | ∘ |
| Example 4 | 0 | 80 | 20 | Not Leaked | Less than 5° C. | ∘ |
| Example 5 | 0 | 90 | 10 | Not Leaked | 43° C. | ∘ |

L1, L2, and L3 cited in Table 1 are set forth below:

L1: In planar view, a distance from a joint portion of the water-repellent film and the exterior body to an outer end portion of the catalyst layer, when a distance of 100 is set between: a joint portion of the water-repellent film and the exterior body; and the exterior body and a separator;

L2: In planar view, a distance from the joint portion of the water-repellent film and the exterior body to an outer end portion of the positive electrode current collector, when a distance of 100 is set between: the joint portion of the water-repellent film and the exterior body; and the exterior body and the separator; and

L3: In planar view, a distance from the outer end portion of the positive electrode current collector to a portion at which the exterior body and the separator join together, when a distance of 100 is set between: the joint portion of the water-repellent film and the exterior body; and the exterior body and the separator.

Note that, as to L1 and L2, the sign + denotes a direction toward the outside.

### Evaluation

For each of the samples produced in Examples 1 to 5 and Comparative Example 1, (1) a drop test and (2) a discharge test were conducted. Table 1 shows the results.

### (1) Drop Test

Each of the samples produced in Examples 1 to 5 and Comparative Example 1 was dropped from a height of 1 m onto concrete. After that, the samples were visually checked for presence or absence of leakage of liquid (leakage of electrolytic solution). In Table 1, the column “Presence or Absence of Leakage of Liquid after Drop Test” shows the results. In Table 1, the term “Leaked” denotes that leakage of liquid occurred. The term “Not Leaked” denotes that leakage of liquid did not occur.

Moreover, for each of the dropped samples, a temperature rise of the sample was measured while the sample was left at a temperature of 25° C. In Table 1, the column “Temperature Rise after Drop Test” shows the results. Each of Comparative Example 1 and Examples 1 to 4 exhibited a temperature rise of less than 5° C. Whereas, Example 5 exhibited a temperature rise of 43° C.

### (2) Discharge Test

A discharge test was conducted to the samples subjected to the above drop test. The samples were discharged while a constant current of 3 A was drawn at a temperature of 25° C. After that, the samples were visually checked for presence or absence of leakage of liquid. In Table 1, the column “Result of Leakage of Liquid after Discharge Test” shows the results. The reference signs “×”, “Δ”, and “○” denote the following:

×: A leakage of liquid occurred within five hours after the start of discharge.

Δ: A leakage did not occur within five hours after the start of discharge. However, the electrolytic solution dried up in two days.

○: A leakage did not occur within five hours after the start of discharge. The dry-up of the electrolytic solution was not observed in two days.

As can be understood from the results cited in Table 1, in an example (Comparative Example 1) in which the catalyst layer has no portion positioned between: the joint portion of the exterior body and the water-repellent film; and the positive electrode current collector, a leakage of liquid occurred after the drop test. Meanwhile, in examples (Examples 1 to 5) in which the catalyst layer has a portion positioned between: the joint portion of the exterior body and the water-repellent film; and the positive electrode current collector, a leakage of liquid was not observed after the drop test.

In an example in which, in planar view, a distance (L2) of less than 20 was set from the joint portion of the water-repellent film and the exterior body to the outer end portion of the positive electrode current collector, when a distance of 100 was set between: the joint portion of the water-repellent film and the exterior body; and the exterior body and the separator, the leakage and dry-up of liquid occurred; whereas, in an example in which a distance (L2) of 20 or more was set, neither the leakage nor the dry-up of liquid was observed.

Moreover, in an example in which, in planar view, a distance (L3) of less than 20 was set from the outer end portion of the positive electrode current collector to the portion at which the exterior body and the separator join together, when a distance of 100 was set between: the joint portion of the water-repellent film and the exterior body; and the exterior body and the separator, the temperature rose significantly after the drop test; whereas, in an example in which a distance (L3) of 20 or more was set, the temperature did not rise significantly after the drop test.

1. A metal-air battery, comprising:
a positive electrode including: a current collector; and a catalyst layer formed on the current collector and capable of reducing oxygen;
a negative electrode disposed to face the positive electrode;
an exterior body housing a stacked portion including the positive electrode and the negative electrode, and having an opening formed to open to the positive electrode;
an electrolyte disposed inside the exterior body; and
a water-repellent film covering the opening, including a joint portion joined to the exterior body, and transparent to oxygen,
wherein the catalyst layer includes a portion positioned between the joint portion and the current collector.

2. The metal-air battery according to claim 1,
wherein the catalyst layer is thicker than the electrode current collector.

3. The metal-air battery according to claim 1 or 2,
wherein the catalyst layer covers all of a surface, of the joint portion, toward the current collector.

4. The metal-air battery according to claims 1,
wherein the current collector is formed of a metal porous solid.

5. The metal-air battery according to claims 1,
wherein the water-repellent film is formed of a porous film.

6. The metal-air battery according to claim 1,
wherein the catalyst layer contains a plurality of catalyst particles.

7. The metal-air battery according to claim 6,
wherein the catalyst layer further includes resin disposed between the plurality of particles.

8. The metal-air battery according to claim 1,
wherein the current collector includes an outer portion positioned out of the catalyst layer.

9. The metal-air battery according to claim 1, further comprising
a lead electrically connected to an outer portion of the current collector, and extending out of the exterior body.

10. The metal-air battery according to claim 1, further comprising
a separator disposed between the positive electrode and the negative electrode.

11. The metal-air battery according to claim 10,
wherein the separator is joined to the exterior body, and
in planar view, when a distance of 100 is set between: a portion at which the separator and the exterior body join together; and a joint portion of the water-repellent film and the exterior body, a distance of 20 or more is set between: the joint portion of the water-repellent film and the exterior body; and an end portion of the catalyst layer.

12. The metal-air battery according to claim 11,
in planar view, a distance of 20 or more is set between: the joint portion of the water-repellent film and the exterior body; and an end portion of the current collector.

13. The metal-air battery according to claim 1,
wherein the current collector has a thickness of 50 μm or more and 500 μm or less.

14. The metal-air battery according to claim 1,
wherein the catalyst layer has a thickness of 200 μm or more and 1000 μm or less.

15. The metal-air battery according to claim 1,
wherein the water-repellent film has a thickness of 10 μm or more and 300 μm or less.
